(19) United States
(12) Patent Application Publication
(10) Pub. No.: US 2003/0127302 A1
(43) Pub. Date: Jul. 10, 2003

(54) Regulatory gate system for product drop off of vibratory conveyors

(76) Inventor: Marvin Vincent Brewer, Frisco, TX (US)

Correspondence Address: CARSTENS YEE & CAHOON, LLP, P O BOX 802334, DALLAS, TX, 75380

(21) Appl. No.: 09/774,892

(22) Filed: Jan. 31, 2001

(51) Int. Cl. B65G 47/26

(52) U.S. Cl. 198/436

(57) ABSTRACT

An improved method and apparatus for distributing a food product, such as potato chips, which provides a laminar flow of product to the weighers. The laminar flow of product is provided using a gate which regulates the amount of product dropped through the distribution conveyor to an amount that is equivalent to the flow rate created by the set of weighers/bagmakers associated with that gate. This results in some of the product being deposited through the gate while the remainder of the product bypasses the gate for deposit in a subsequent gate.

### BACKGROUND OF THE INVENTION

1. Technical Field

The present invention relates to an improved product conveyor apparatus and, in particular, to a product conveyor apparatus which provides for a laminar flow of product to downstream gates thereby increasing the efficiency of downstream bagmakers for a given conveyor line.

2. Description of Related Art

A vibratory conveyor is a commonly used device in the food industry for transporting products such as potato chips to weighers. In most packaging lines, a product is moved along vibratory distribution conveyors having multiple sets of product weighers placed beneath the length of the conveyor. When a set of weighers requires product, a slide gate opens in the bottom of the distribution conveyor to drop product onto a cross-feeder conveyor which serves that set of weighers. It is possible that the product might pass over all of the slide gates without being dropped because the slide gates are closed when the product passes over. Rather than simply discarding the product that was not dispensed from the distribution conveyor, a recirculation conveyor is typically used to re-route the undispensed product back to the beginning of the distribution conveyor.

An example of a prior art design in this regard is illustrated by FIG. 1A. Throughout the specification, the same numerals are used to denote like parts unless otherwise indicated. FIG. 1A shows a top view of a distribution conveyor 100 with a plurality of slide gates 105 and a recirculation conveyor 115. The distribution conveyor 100 consists of multiple sections of distribution conveyor pans (not shown), each having a plurality of slide gates 105 mounted in the bottom of the conveyor pan. The conveyor pans vibrate in the direction of product flow 125. In operation, the pan drops downward and in the opposite direction of product flow, and then lifts upward and forward in the direction of product flow 125 at a high frequency. In this manner, the product is moved to a higher elevation at the end of each distribution conveyor pan before it is dumped onto the next distribution conveyor pan at a lower elevation.

The slide gates 105 are each controlled by a pneumatic controller connected to product level sensors on a cross-feeder conveyor serving a set of weighers located to one side and beneath the slide gate 105. The controller opens the slide gate 105 when more product is needed on the cross-feeder conveyor serving the set of weighers. An ultrasonic level sensor may be used on this cross-feeder conveyor to determine when more product should be dispensed from the distribution conveyor. Thus, each slide gate 105 operates independently of the other slide gates. The recirculation conveyor pans (if used) are similar in operation to the distribution conveyor pans except that they may not have slide gates, operating simply to move the product back to the initial stage 120 of the distribution pan 100.

FIG. 1B shows the distribution conveyor 100 in operation. The product 140, such as potato chips, comes out of the kitchen and is deposited onto the initial stage 120 of the distribution conveyor 100. It passes over multiple slide gates until it is dropped into an open slide gate 105. If the product passes over all of the slide gates without being dropped, then it is either dumped as waste or deposited onto the upstream end 130 of the recirculation conveyor 115 and re-routed back to the initial stage 120 of the distribution conveyor 100. In a typical prior art system, approximately 20% of the product is re-routed down the recirculation conveyor back to the distribution conveyor. One of the reasons for this is that the slide gates only open periodically. When a gate opens, most, if not all, of the product upstream of the gate is deposited as it reaches the gate with very little product allowed to bypass the gate until it is completely shut. Some gates extend across the entire width of the conveyor pan while other gates extend over a substantial portion of the width of the conveyor. The prior art slide gates operate such that they are either fully opened or fully closed. Because the slide gate 105 extends across the entire width or at least a substantial portion of the width of the distribution conveyor, this on/off system results in gaps 110 in the product forming on the conveyor downstream of the slide gate 105. Thus, when a slide gate further downstream opens, there is a good chance that there will be no product immediately available and the set of weighers fed through that slide gate will be starved of product. This means that the weighers/bagmakers are operating inefficiently because they do not always have product available when needed. Using the systems of the prior art, additional weighers/bagmakers must be attached to the conveyors to obtain a higher throughput even though the weighers are not being operated at 100% of their capacity. This increases the overall cost of the product line. A smaller number of weighers/bagmakers would be required for a given 1 throughput if a laminar flow of product were available to the weighers. For example, if the desired throughput is 4000 bags per hour on a product line and each bagmaker has a capacity of 1000 bags per hour, a non-laminar flow of product may decrease the efficiency of each bagmaker to 80% or 800 bags per hour. Thus, in order to get the desired throughput of 4000 bags per hour, at least five bagmakers must be used. However, if a laminar flow of product is provided such that the bagmakers operate at 100% efficiency, then only four bagmakers would be required for the desired throughput.

A non-laminar product flow also causes more of the product to be re-circulated on the recirculation conveyor 115. The longer the product remains on the conveyor, the more it cools and, consequently, the more moisture that is absorbed by the product. As the product is circulated from the distribution conveyor 100 to the recirculation conveyor 115 and back to the distribution conveyor 100, it will decrease in temperature to the point that the vapor pressure of the product is exceeded by the surrounding atmosphere. When this happens, the product absorbs moisture from the atmosphere, increasing its moisture content. Excess moisture in a packaged product can lead to premature staling. The shelf life of the packaged product is therefore reduced when the product makes a subsequent pass on the distribution conveyor 100. Furthermore, even if only a portion of the product packaged in a bag had been recirculated, the absorbed moisture of the recirculated product would also affect the product that had not absorbed any moisture, causing it to go stale faster as well.

Environmental conditions of the room can be controlled by increasing the temperature and decreasing the humidity. This is not a feasible solution because the equipment needed to control the environment in the room is extremely expensive to purchase, operate, and maintain. Another alternative is to keep the product warmer by using infrared heaters placed above the product. Using this method to keep the product warm, the product could theoretically be circulated for hours at higher than room temperature without absorbing moisture from the ambient air. However, the obvious shortcoming of this solution is that it would require an electrical or gas energy source. This added energy cost decreases the profitability of the operation and makes it a much less attractive solution. Further, maintaining the product at an elevated temperature for an extended period of time could affect the characteristics and quality of the product.

U.S. patent application Ser. No. 09/417,962, hereby incorporated by reference as if fully set forth herein, the inventor of the present invention discloses a stopper gate that reduces the amount of product that is recirculated on the recirculation conveyor. However, the stopper gate system disclosed therein does not eliminate all flow fluctuations of product on the distribution conveyor that causes the weighers/bagmakers to operate inefficiently.

Thus, the best solution is to develop a method and apparatus for dispensing the product into the weighing mechanism as soon as possible after it enters the packaging line, preferably on the first pass of the product through the distribution conveyor. The system should provide for a laminar flow of product to be fed into the weighing mechanism to avoid any starvation of the weighers and to reduce the amount of product that is recirculated. With such a system, the weighers may be operated at maximum capacity, thereby requiring fewer weighers for a given throughput on the product line.

### SUMMARY OF THE INVENTION

The present invention is an improved method and apparatus for distributing a food product, such as potato chips to a set of weighers. The invention provides a laminar flow of product to the weighers by using a gate which regulates the amount of product dropped through the distribution conveyor to an amount that is equivalent to the flow rate required by the set of weighers/bagmakers associated with that gate. The gate is constructed such that it may be partially open to allow some product to be dropped through the gate while concurrently bypassing the remainder of the product. This results in a steady stream of product continuing downstream for deposit in a subsequent gate. Thus, the downstream weighers/bagmakers are not starved of product because of product voids on the distribution conveyor. Consequently, a higher throughput may be obtained with the same number of weighers while the amount of product recirculated is also reduced. The above as well as additional features and advantages of the present invention will become apparent in the following written detailed description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings wherein:

FIG. 1A is an overhead schematic of a prior art conveyor system.

FIG. 1B is an overhead schematic of a prior art conveyor system in operation.

FIG. 2 is a perspective view of a portion of a conveyor system in accordance with an embodiment of the present invention.

FIG. 3A is a top view of a finger gate in accordance with one embodiment of the present invention.

FIG. 3B is a bottom view of the finger gate of FIG. 3A in accordance with one embodiment of the present invention.

FIG. 3C is a cross-sectional view of the finger gate of FIGS. 3A and 3B.

FIG. 4A is a bottom view of a V-gate in a partially closed position in accordance with one embodiment of the invention.

FIG. 4B is a bottom view of a V-gate in an open position in accordance with one embodiment of the invention.

FIG. 5 is a perspective view of a diverter gate in accordance with one embodiment of the present invention.

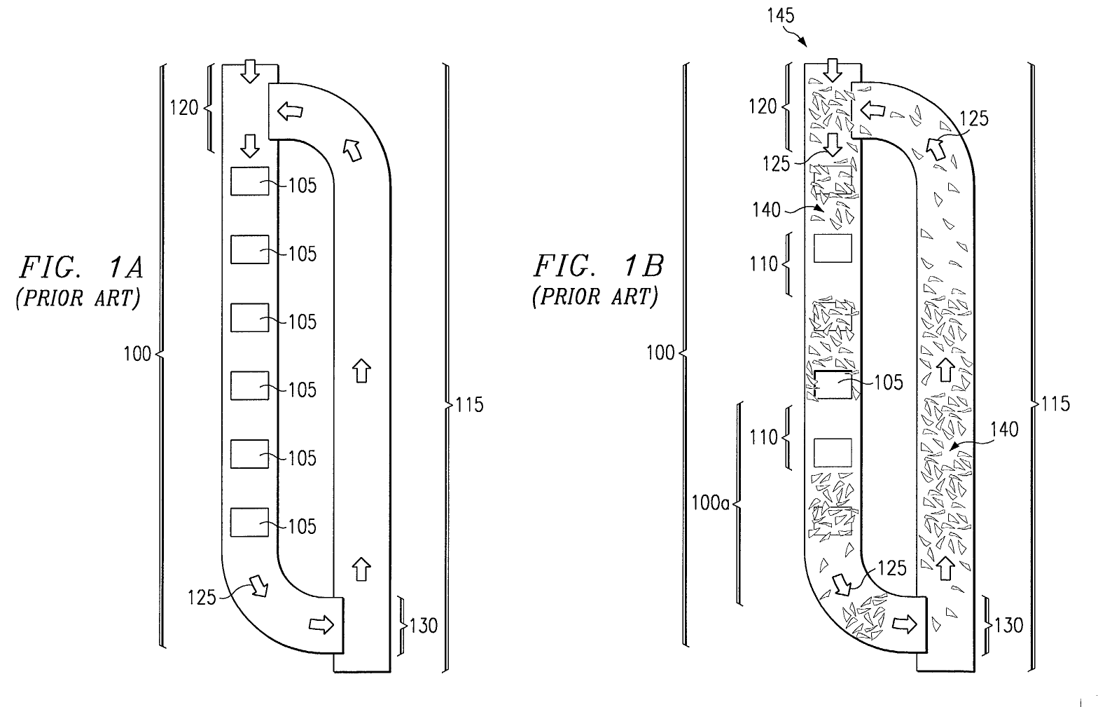

### DETAILED DESCRIPTION

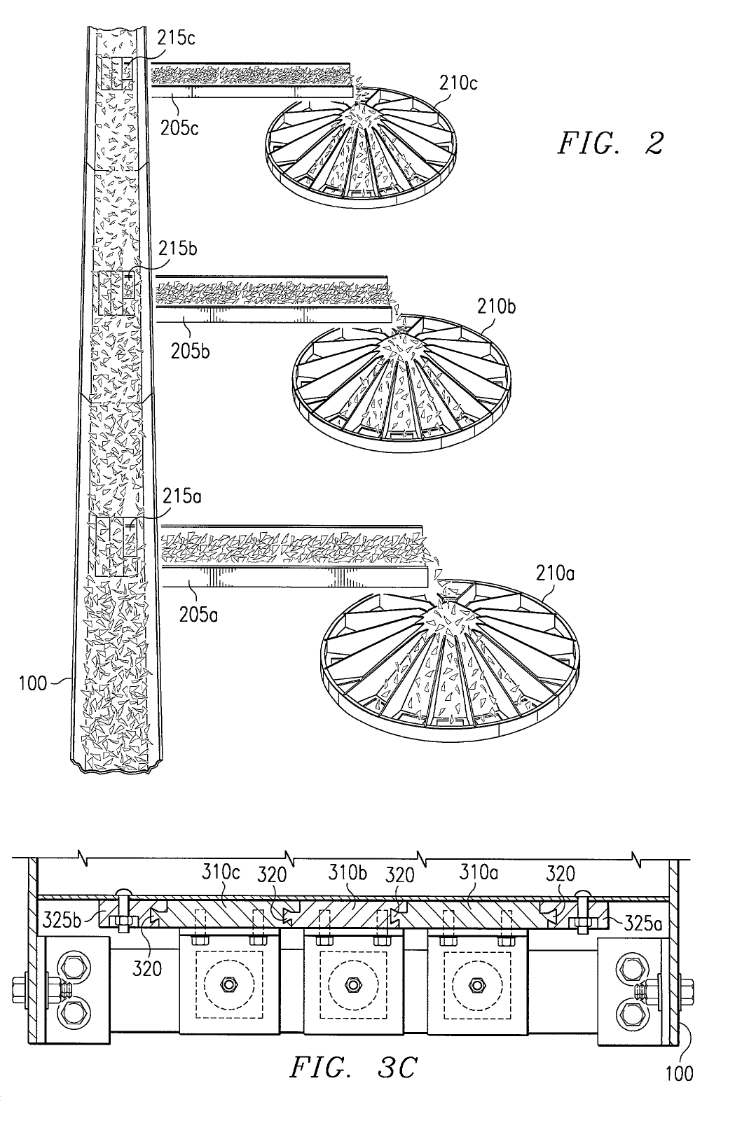

FIG. 2 is a perspective view of a portion of a conveyor system in accordance with an embodiment of the present invention. Product flows down distribution conveyor 100 and is dropped through an open slide gate 215a onto a cross-feeder conveyor 205a for a set of weighers 210a. The cross-feeder conveyor 205a may also be a vibratory conveyor similar to the distribution conveyor 100. The slide gate 215a is generally only partially open to allow some of the product to bypass the slide gate to be dropped through the remaining slide gates. By regulating the size of the opening of the slide gate 215a, the volume of product to the cross-feeder conveyor 205a is regulated to an amount that provides a steady flow of product to the set of weighers 210a without creating a void in the product on the distribution conveyor 100. The vibration of the distribution conveyor 100 has a tendency to distribute the remainder of the product across the width of the conveyor after it passes over a partially open slide gate 215a. Thus, there are no voids in the flow of product once it reaches a subsequent slide gate 215b.

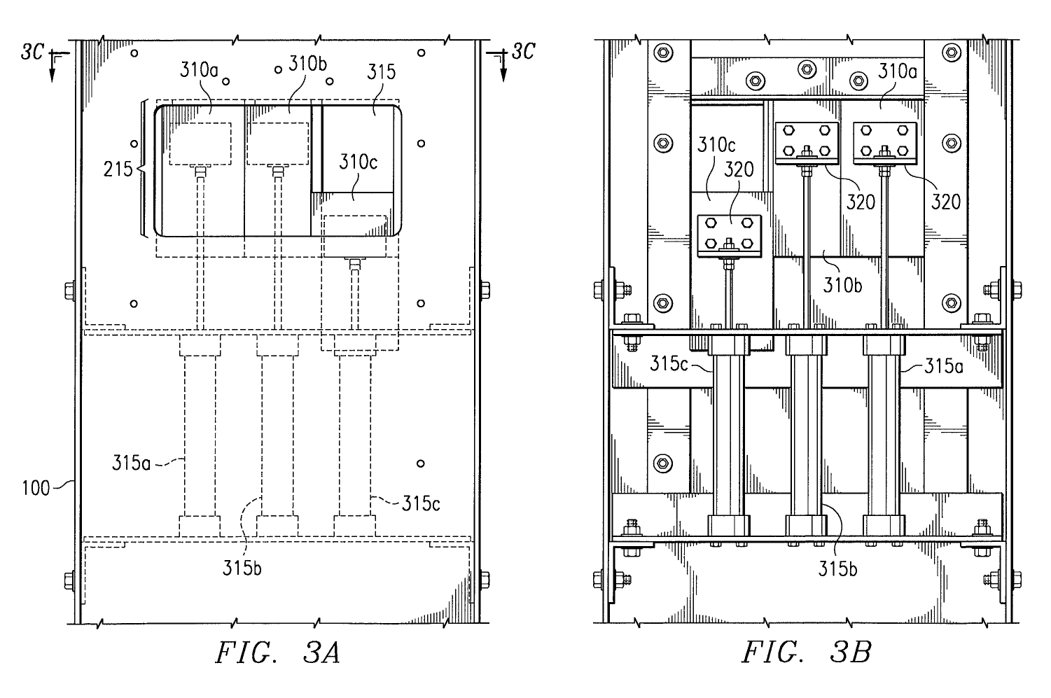

FIG. 3A is a top view of a finger gate in accordance with one embodiment of the present invention. Rather than have one solid slide gate that is either open or closed, the embodiment illustrated provides three separate fingers 310a, 310b, and 310c which are independently actuated by pneumatic actuators 315a, 315b, and 315c located underneath the distribution conveyor 100. When one finger is opened, a slot is created which is aligned with the direction of product flow. This allows all of the product flowing down a path in-line with the slot to be dropped while the product that is not flowing down that path continues flowing downstream to be dropped through a subsequent slide gate. In operation, the fingers may be all closed at one time; one finger may be open and the other two closed; two fingers may be open and the third finger closed; or all three fingers may be open. In one embodiment, the right finger 310c opens first, followed by the middle finger 310b and finally the left finger 310a. The fingers are closed in the reverse sequence. However, other sequencing combinations can be used in the alternative without departing from the scope and spirit of the invention. In this embodiment, the opening size created by opening the first finger 310c is set to provide the proper throughput to the cross-feeder conveyor for the set of weighers when a normal level of product is flowing down the distribution conveyor 100 and all of the weighers/bagmakers are operating properly. This is referred to as a normal mode of operation. However, if the product level on the distribution conveyor is lower than normal or if there is a sudden demand for product by the weighers, then it may be necessary to open more than one of the fingers.

The number of fingers open at any given time depends on the level of the product sensed by one or more ultrasonic level sensors in the cross-feeder conveyor 205 associated with the slide gate 215. Thus, the slide gate provides a regulatory function in that it regulates the size of the opening 315 to control the amount of product that is allowed to flow through the slide gate 215. By controlling the opening 315 to regulate the product until a steady flow of product is achieved, a laminar flow along the distribution conveyor 100 and the cross-feeder conveyor 205 is provided. When only one or two of the fingers are open, some of the product bypasses the slide gate 215 for deposit through subsequent slide gates. Once product passes the slide gate 215, the vibration of the conveyor redistributes the product evenly across the width of the conveyor 100 before it reaches a subsequent slide gate. Thus, the flow of product downstream of the finger gate 215 is much more laminar than it is if the single-piece slide gate of the prior art is used. In practice it has been observed that the left finger 310a usually remains closed. The middle finger 310b opens and closes as the needs of the set of weighers change, and the right gate 310c usually always remains open. Although the number of fingers used in the embodiment illustrated is three, the invention is not limited to three fingers. More fingers may be used to provide for a greater number of sizes for the slide gate opening.

FIG. 3B is a bottom view of the finger gate of FIG. 3A in accordance with one embodiment of the present invention. Only the right finger 310c is in the open position. The finger gates 310a, 310b, and 310c are each actuated using independently operated pneumatic actuators 315a, 315b, and 315c. The fingers may be constructed of Ultra High Molecular Weight (UHMW) polymer boards with a bracket 320 attached to each of the fingers 310a, 310b, and 310c. The bracket 320 is attached to the ram of a pneumatic actuator for each finger. The actuators 315a, 315b, and 315c are controlled by a controller which has an analog connection to an ultrasonic sensor that is placed on the cross-feeder conveyor 205a located below the distribution conveyor 100, as shown in FIG. 2. A suitable controller is the Model PAXP single loop controller manufactured by Red Lion. Ultrasonic sensors are used extensively in the food industry to measure product level because of their accuracy. A suitable sensor is the Hyde Park SM956 series. However, the invention is not limited to this particular ultrasonic sensor or loop controller. Any sensor capable of detecting a pre-defined product level at a particular location on the cross-feeder conveyor is sufficient for the purposes of this invention. Likewise, any controller that is capable of operating the three actuators to regulate the size of the opening is sufficient for the purposes of this invention.

The controller is programmed to maintain the product level in the cross-feeder conveyor at a predetermined operating level, such as two inches. When the product line is first started with no product in the distribution conveyor, the controller opens all three fingers 310a, 310b, and 310c. Once the product builds up on the cross-feeder conveyor to more than the predetermined operating level, the left finger 310a is first closed. After a predetermined period of time, the controller will close the middle finger 310b if the product level is still above the predetermined operating level. The controller then waits for the predetermined period of time and if the product is still above the predetermined operating level, the right finger 310c is closed. The same procedure is followed when the product drops below the predetermined operating level except that the gates are opened one at a time in the reverse order until the product rises back to the predetermined operating level.

The controller uses a debounce timer to desensitize the system so that the fingers on the slide gate are not constantly opening and closing. Naturally, the product level on the cross-feeder conveyor may drop rapidly when the slide gate is closed or rise rapidly when all three fingers are open, but it is not desirable for a finger to open immediately after it is closed, or vice versa. The debounce timer is simply a delay created by the software of the control system that keeps the finger on the slide gate open (closed) for a predetermined time period before allowing it to close (open) again, regardless of the level of product sensed on the cross-feeder conveyor.

FIG. 3C is a cross-sectional view of the finger gate of FIGS. 3A and 3B oriented as shown in FIG. 3A. The view shows the dovetail grooves 320 on the edges of the fingers that allow the fingers to interlock and prevent product from becoming lodged between the fingers. The fingers interlock laterally while the fingers are allowed to slide freely in a longitudinal direction parallel to the direction of product flow. Stationary mounting strips 325a, 325b are attached near the outer edges of the opening of the distribution conveyor 100 to interlock with and hold the outer fingers 310a, 310c in place. Because the outer fingers 310a, 310c are interlocked laterally with the middle finger 310b, the middle finger is also held in position by the stationary mounting strips 325a, 325b.

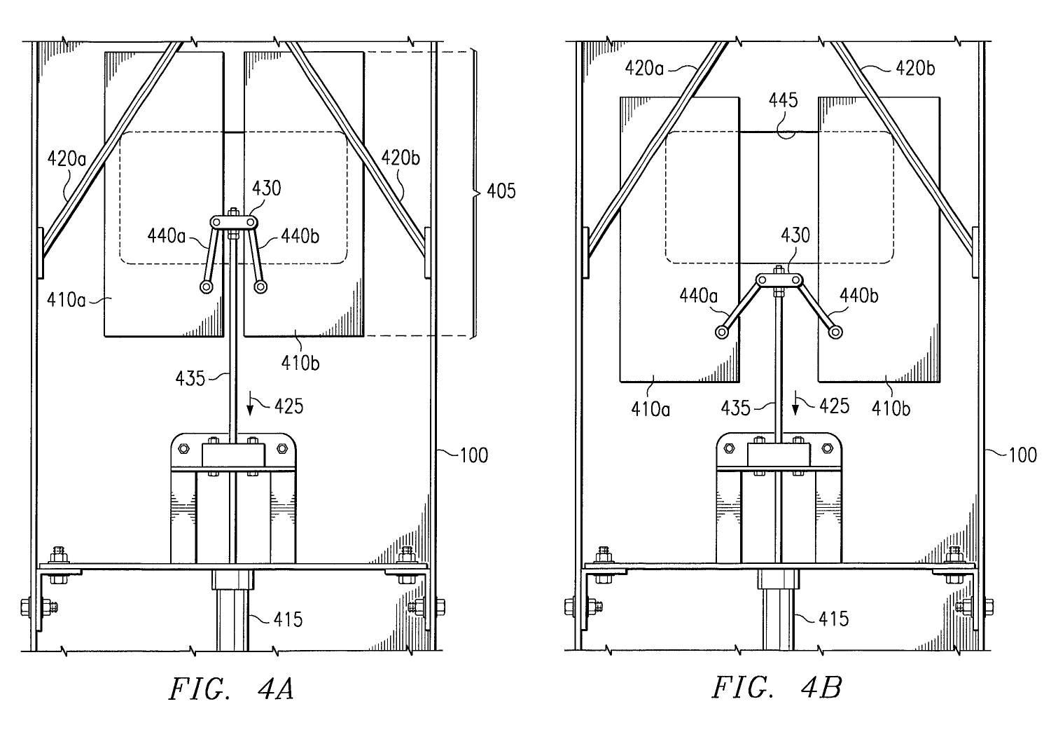

FIG. 4A is a bottom view of a V-gate in a partially closed position in accordance with an alternative embodiment of the invention. The slide gate 405 illustrated in this embodiment is referred to as a V-gate 405 because of the movement of the gate. Two rectangular pieces of UHMW board 410a, 410b, or other suitable material, are attached to a pneumatic actuator 415 which operates parallel to a longitudinal axis of the distribution conveyor 100 to vary the size of the opening in the gate. The end of the actuator ram 435 is rigidly attached to a coupling linkage 430 which is perpendicular to the actuator ram 435. The ends of the coupling linkage 430 contain holes for mounting the links 440a, 440b that connect the UHMW boards 410a, 410b to the coupling linkage 430. Each end of the links 440a, 440b houses a bearing surface to allow the links 440a, 440b to rotate as the slide gate is opened and closed.

The UHMW boards 410a, 410b contain symmetrical grooves (not shown) to accept the guides 420a, 420b which are attached rigidly to the bottom of the distribution conveyor 100 such that the guides form a “V.” The angle between the guides is twice the acute angle formed between one of the grooves and the longitudinal axis of the distribution conveyor 100. Thus, the V-gate is symmetrical about the longitudinal axis of the distribution conveyor 100. The guides may be fabricated from square stock steel and attached to the bottom of the distribution conveyor. Thus, whenever the actuator ram 435 is operated in a rearward direction 425, the boards 410a, 410b are forced apart by the guides 420a, 420b and whenever the actuator is operated in a forward direction, the boards 410a, 410b are forced together by the guides. FIG. 4A shows the V-gate 405 in a slightly open position while FIG. 4B shows the V-gate in a more fully open position. Whenever the gate is opened, the actuator pulls the UHMW boards 410a, 410b in the rearward direction 425, forcing the boards toward the outside edges of the distribution conveyor 100, thereby providing an opening 445 for the product to fall through. A pneumatic actuator 415 may be used with the V-gate just as it is used in the embodiment shown in FIG. 3A and FIG. 3B. However, only one actuator is required for the V-gate embodiment. Thus, the existing pneumatic actuator may be used in converting a prior art system to the V-gate embodiment. The actuator may be controlled using a programmable logic controller such as the Position X Remote PLC manufactured by Robohand, Inc.

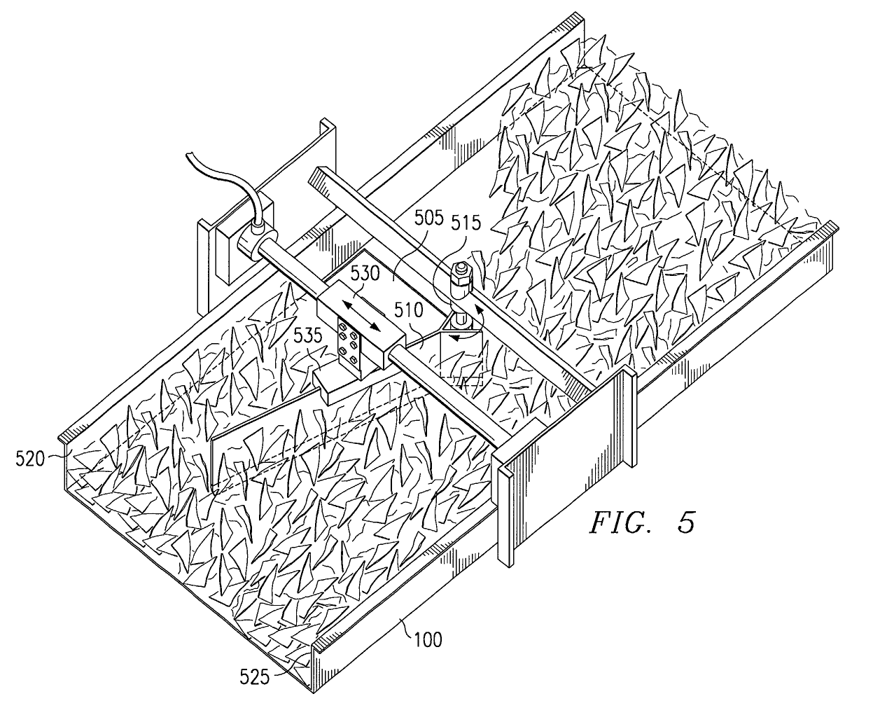

FIG. 5 is a perspective view of a diverter gate in accordance with another embodiment of the present invention. The diverter gate of FIG. 5 is different from the finger gate or the V-gate described above in that the opening 505 in the distribution conveyor 100 remains open at all times. The amount of product flow through the opening 505 is controlled by the diverter 510. The diverter 510 is rotably attached to the structure of the distribution conveyor such that it pivots about a bearing surface 515. The diverter 510 is moved from side to side to control the amount of product that is allowed to flow through the opening 505. If no product is needed by the weigher associated with the opening 505, then the diverter 510 is moved to the left side 520 of the distribution conveyor such that all of the product is bypassed around the opening 505. The position of the diverter 510 is varied such that the proper flow rate of product through the opening 505 is obtained. The position of the diverter 510 may be controlled using a magnetically coupled rodless cylinder 530 such as a Festo Type DGO. The cylinder is attached to the diverter 510 using UHMW swivel blocks 535 or other suitable connections. As the actuator 530 moves from side to side, the diverter 510 swings from side to side. The swivel blocks 535 allow the diverter 510 to move within the swivel blocks. The same programmable logic controller used for the V-gate described above may be used for controlling the diverter gate.

The above conveyor systems present novel and non-obvious features in the product packaging field. Several gates are described which are capable of satisfying the several objects of this invention. However, this invention should not be construed to be limited to the specific constructions described herein, but rather may be embodied in structures which change one or several of the disclosed features of the illustrated gates. It is to be understood that the invention is intended to cover all changes and modifications to the gates as depicted herein, and all other embodiments not specifically illustrated, which do not constitute a departure from the true spirit and scope of this invention.

For example, the dimensions may be changed to increase or decrease the overall size of the gates; the shapes and number of the finger gates, V-gates, or diverter gates may also be changed; the individual materials and devices may be changed to other comparable materials which accomplish the same purpose; and products other than potato chips may be used with the invention. Although not shown in the drawings, the invention may also be used in combination with the stopper gate disclosed in U.S. patent application Ser. No. 09/417,962 to help reduce the amount of product that is recirculated. The invention could also be used in the industry where conveyors are used to distribute products other than food products.

What is claimed is:

1. An apparatus for regulating a flow rate of product dropped from a conveyor, said apparatus comprising:
a gate for controlling a size of an opening in said conveyor wherein said gate may be partially opened to allow some product to drop through said opening while other product passes along a side of said opening for deposit in a subsequent gate on said conveyor;
a control system for regulating said size of said opening in said conveyor wherein said control system regulates said size of said opening based on a demand for said product to be dropped from said conveyor.

2. The apparatus of claim 1 wherein said gate comprises a plurality of fingers and said control system actuates said plurality of fingers independently to control said size of said opening.

3. The apparatus of claim 2 wherein said control system comprises a plurality of pneumatic actuators each of which is connected to a corresponding one of said plurality of fingers.

4. The apparatus of claim 2 wherein a longitudinal axis of said plurality of fingers is aligned with a longitudinal axis of said conveyor.

5. The apparatus of claim 4 wherein responsive to a demand for said product, an outside finger is first opened to allow said product to drop from said conveyor, and wherein responsive to a demand for more product after said outside finger has been open for a predetermined time, an adjacent finger is opened to make said size of said opening larger and wherein responsive to a determination that too much product is being dropped from said conveyor, said adjacent finger and said outside finger are closed one at a time in a reverse sequence to make said size of said opening smaller.

6. The apparatus of claim 1 wherein said gate comprises two boards movably attached to said conveyor wherein responsive to a force acting in a first direction on said two boards, said two boards move closer together thereby decreasing said size of said opening and wherein responsive to a force acting in a second direction opposite to said first direction, said two boards move apart thereby increasing said size of said opening.

7. The apparatus of claim 6 wherein said gate further comprises an actuator attached to said two boards for applying a force to said two boards for opening and closing said gate.

8. The apparatus of claim 7 wherein said actuator may position said two boards in any position between a fully open position and a fully closed position.

9. The apparatus of claim 1 wherein said control system comprises:
a pneumatic controller having an analog input from a level sensor and a pneumatic output such that said controller determines said demand for said product based on said analog input from said level sensor; and
a pneumatic actuator attached to said gate for opening and closing said gate, wherein responsive to a determination by said controller that more product is needed, said controller moves said pneumatic actuator to increase said size of said opening, and responsive to a determination that less product is needed, said controller moves said pneumatic actuator to decrease said size of said opening.

10. The apparatus of claim 1 wherein said gate increases said size of said opening by increasing a width of said opening wherein a length of said opening measured in a direction of product flow remains constant while said gate is in an open position.

11. An apparatus for regulating a flow rate of product dropped from a conveyor, said apparatus comprising:
a plurality of sliding members for covering an opening in said conveyor wherein each of said sliding members is interlocked with an adjacent sliding member such that each of said sliding members is movable in a longitudinal direction with respect to said adjacent sliding member and said conveyor and wherein each of said sliding members is fixed in a lateral direction with respect to said adjacent sliding member and said conveyor;
a plurality of mounting strips attached to a bottom of said conveyor for fixing said plurality of sliding members in said lateral direction wherein each of said plurality of mounting strips attaches adjacent to said opening and interlocks with an outside sliding member of said plurality of sliding members to hold said plurality of sliding members in place in said lateral direction while allowing said plurality of sliding member to move freely in said longitudinal direction;
a plurality of actuators for independently actuating each of said plurality of sliding members wherein a first end of each of said plurality of actuators is attached to said conveyor and wherein a second end of each of said plurality of actuators is attached to a respective one of said plurality of sliding members for moving said one of said plurality of sliding members in said longitudinal direction;
a controller for controlling said plurality of actuators wherein said controller determines an amount of product to be dropped from said conveyor and then actuates a corresponding number of said plurality of actuators such that said opening is of a size to allow said amount of product to fall from said conveyor.

12. The apparatus of claim 11 wherein said controller opens said plurality of sliding members in a predefined sequence and closes said plurality of sliding members in a reverse order of said predefined sequence.

13. The apparatus of claim 12 wherein said predefined sequence comprises starting by opening an outer sliding member and then opening an adjacent sliding member.

14. The apparatus of claim 13 wherein a size of said opening made by opening said outer sliding member is set such that a flow rate of product through said opening during a normal mode of operation is equivalent to said amount of product to be dropped.

15. An apparatus for regulating a flow rate of product dropped from a conveyor, said apparatus comprising:
a first sliding member for covering a first side of an opening in said conveyor wherein said first sliding member contains a first groove for guiding said first sliding member as it slides at an acute angle to a longitudinal axis of said conveyor;
a second sliding member for covering a second side of said opening in said conveyor wherein said second sliding member contains a second groove for guiding said second sliding member as it slides at said acute angle;
a first guide attached to said conveyor for holding said first sliding member in place;
a second guide attached to said conveyor for holding said second sliding member in place;
an actuator attached on a first end to said first sliding member and said second sliding member and attached on a second end to said conveyor such that responsive to said actuator moving in a first direction said first sliding member and said second sliding member are moved closer together and responsive to said actuator moving in a second direction said first sliding member and said second sliding member are moved apart thereby increasing size of said opening; and
a controller for controlling said actuator wherein said controller determines an amount of product to be dropped from said conveyor and then moves said actuator to a position that will allow said amount of product to fall from said conveyor.

16. The apparatus of claim 15 wherein said first sliding member and said second sliding member are of a same rectangular shape wherein in a closed position a long inner edge of said first sliding member and a long inner edge of said second sliding member fit together to cover said opening.

17. The apparatus of claim 15 wherein said first sliding member is placed between said first guide and a bottom of said conveyor such that said first guide holds said first sliding member against said bottom of said conveyor and wherein said second sliding member is placed between said second guide and said bottom of said conveyor and wherein an angle between said first guide and said second guide is approximately twice said acute angle.

18. The apparatus of claim 15 wherein said actuator is attached to said first sliding member with a first link rotably mounted to said actuator and said first sliding member and wherein said actuator is attached to said second sliding member with a second link rotably mounted to said actuator and said second sliding member.

19. An apparatus for distributing product to a plurality of sets of bagmakers comprising:
a distribution conveyor for conveying said product to a plurality of gates located in said distribution conveyor;
a plurality of cross-feeder conveyors for conveying product to said plurality of sets of bagmakers from said distribution conveyor;
a first gate in said distribution conveyor for metering a flow of product to a first cross-feeder conveyor wherein during a normal mode of operation said first gate is partially open such that a portion of said product is dropped through said first gate and a remainder of said product bypasses said gate for deposit in a subsequent gate.

20. The apparatus of claim 19 wherein a size of an opening of said first gate is based on a level of product in said first cross-feeder conveyor and wherein said size is adjusted to provide a steady flow of product to said first cross-feeder conveyor.

21. The apparatus of claim 20 wherein said first gate is a finger gate.

22. The apparatus of claim 20 wherein said first gate is a V-gate.

23. The apparatus of claim 20 wherein said first gate is a diverter gate.

24. A method of regulating a flow rate of product dropped from a conveyor, said method comprising:
determining a demand for said product;
opening a gate to a position corresponding to said demand for said product wherein in a normal mode of operation some product is dropped through an opening in said conveyor while other product passes along a side of said opening for deposit into a subsequent gate on said conveyor.

25. The method of claim 24 further comprising controlling said gate using a computerized control system for opening and closing said gate wherein said control system regulates said size of said opening based on a demand for said product.

26. The method of claim 25 wherein said gate is a finger gate.

27. The method of claim 26 wherein opening only a first finger of said finger gate produces a steady flow of product through said finger gate during said normal mode of operation.

28. The method of claim 25 wherein said gate is a V-gate.

29. The method of claim 25 wherein said gate is a diverter gate.

30. An apparatus for regulating a flow rate of product dropped from a conveyor, said apparatus comprising:
a diverter placed adjacent to an opening in a bottom of said conveyor for controlling an amount of product allowed to fall through said opening wherein said diverter can be rotably positioned to divert a variable amount of said product to said opening;
a control system for varying a position of said diverter based on a demand for said product.

31. The apparatus of claim 30 wherein said diverter is rotably attached to said conveyor such that it rotates responsive to a force applied to a side of said diverter.

32. The apparatus of claim 30 wherein said control system comprises:
a programmable logic controller having a level sensor input;
an actuator mechanically attached to said diverter for rotating said diverter across a width of said conveyor wherein said actuator is controlled by said programmable logic controller.

33. The apparatus of claim 32 wherein said actuator is a magnetically coupled rodless cylinder.

34. The apparatus of claim 30 wherein said variable amount is in a range from none of said product to all of said product being diverted to said opening.
